(19) United States
(12) Patent Application Publication
(10) Pub. No.: US 2010/0166082 A1
(43) Pub. Date: Jul. 1, 2010

(54) METHOD FOR PACKING BITSTREAM OF SCALABLE VIDEO CODING

(75) Inventors: Jung-Yang Kao, Pingtung County (TW); Jih-Sheng Tu, Yilan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: Industrial Technology Research Institute, Hsinchu (TW)

(21) Appl. No.: 12/410,455

(22) Filed: Mar. 24, 2009

(30) Foreign Application Priority Data
Dec. 26, 2008 (TW) 97151116

(51) Int. Cl. H04N 7/26

(52) U.S. Cl. 375/240.26; 375/E07.078

(57) ABSTRACT

A method for packing a bitstream of scalable video coding (SVC) is provided. The method includes the following steps. First, a SVC bitstream is obtained, wherein the SVC bitstream has a plurality of frames, and each of the frames has a base layer and a plurality of enhancement layers. Next, complexity of the frames is analyzed according to the features of a bitstream parameter of the SVC bitstream. Next, the base layers of the frames are selectively packed to form a base layer packet according to the complexity of the frame. Thereafter, the remainder of the SVC bitstream is packed to form a plurality of enhancement layers according to a packing mechanism of the base layer packet.

### CROSS-REFERENCE TO RELATED APPLICATION

This application claims the priority benefit of Taiwan application serial no. 97151116, filed Dec. 26, 2008. The entirety of the above-mentioned patent application is hereby incorporated by reference herein and made a part of specification.

### BACKGROUND OF THE INVENTION

1. Field of the Invention

The present invention relates to a method for packing a bitstream of scalable video coding (SVC).

2. Description of Related Art

In conventional video streaming technology, packing methods of video bitstream packets generally refer to packing by using a Group of Picture (GOP) as a basic unit. However, adaptability to network environments of the above-described packing methods is not satisfactory and is limited to conventional image coding specifications. That is to say, once the above-described packing methods are modified, issues of failure to conform to video format or incorrect video sequence arise. Therefore, a decoder receiving the above-described packets is not able to decode video correctly; thus, the conventional packing methods face a problem of adapting to the network environments.

There are currently two network transmission environments including client-server architecture and a Peer-to-Peer (P2P) technology. The client-server architecture may have a problem of network bandwidth allocation. This means that video cannot be played continuously due to video interruption caused by network congestion when there are too many users in a network, which causes inconvenience to users watching video.

In addition, although the P2P technology solves the problem of the network bandwidth allocation, due to various, disordered and disorganized sources of video bitstream packets, the video decoder receiving the video bitstream will encounter a problem of waiting for sufficient amount of packets before images are actually decoded. Hence, it is very difficult for the P2P technology to apply controls of time to the video streaming, for example, functions of video playing forward and playing backward. Meanwhile, as heterogeneous network gradually arises and video receiver devices become more diverse, single format video streaming may be unable to adapt to such varying video network environments.

### SUMMARY OF THE INVENTION

Consistent with the invention, there is provided a method for packing a bitstream of scalable video coding (SVC). The method for packing a bitstream of SVC includes the following steps. First, a SVC bitstream is obtained. The SVC bitstream includes a plurality of frames, and each of the frames includes a base layer and a plurality of enhancement layers. Next, complexity of the frames is analyzed according to the features of a bitstream parameter of the SVC bitstream. Furthermore, the base layers of the frames are selectively packed to form a base layer packet according to the complexity of the frames. After that, the remainder of the SVC bitstream is packed to form a plurality of enhancement packets according to a packing mechanism of the base layer.

Also consistent with the invention, there is provided a method for packing a bitstream of SVC, the method including following steps. First, a SVC bitstream is obtained, wherein the SVC bitstream includes a plurality of frames, and each of the frames includes a base layer and a plurality of enhancement layers. Complexity of the frames is analyzed according to the features of a first bitstream parameter of the SVC bitstream. The base layers of the frames are further selectively packed to form a base layer packet according to the complexity of the frames. Next, the enhancement layers of the frames corresponding to the base layer packet are packed to form at least a second enhancement packet and at least a third enhancement packet according to a packing mechanism of the base layer packet and the features of a second bitstream parameter and a third bitstream parameter of the SVC bitstream. Three bitstream parameters of the present invention are Motion Vector (MV), Quantization Parameter (QP), and Block Size (BS), respectively.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 shows a schematic diagram of a bitstream having a multi-layer architecture according to one exemplary embodiment consistent with the present invention.

FIG. 2 shows a schematic diagram of a conventional SVC bitstream frame coding.

FIG. 3 shows a flowchart of a method for packing a bitstream of SVC according to one exemplary embodiment consistent with the present invention.

FIG. 4 shows a flowchart of a method for packing a bitstream of SVC according to another exemplary embodiment consistent with the present invention.

FIG. 5A shows a schematic diagram of a result of packing a bitstream of SVC according to a first exemplary embodiment consistent with the present invention.

FIG. 5B shows a schematic diagram of a result of packing a bitstream of SVC according to a second exemplary embodiment consistent with the present invention.

FIG. 5C shows a schematic diagram of a result of packing a bitstream of SVC according to a third exemplary embodiment consistent with the present invention.

FIG. 5D shows a schematic diagram of a result of packing a bitstream of SVC according to a fourth exemplary embodiment consistent with the present invention.

FIG. 5E shows a schematic diagram of a result of packing a bitstream of SVC according to a fifth exemplary embodiment consistent with the present invention.

FIG. 6 shows a flowchart of a method of packing a bitstream of SVC according to still another exemplary embodiment consistent with the present invention.

FIG. 7A shows a schematic diagram of a result of packing a bitstream of SVC according to a sixth exemplary embodiment consistent with the present invention.

FIG. 7B shows a schematic diagram of a result of packing a bitstream of SVC according to a seventh exemplary embodiment consistent with the present invention.

FIG. 7C shows a schematic diagram of a result of packing a bitstream of SVC according to an eighth exemplary embodiment consistent with the present invention.

FIG. 7D shows a schematic diagram of a result of packing a bitstream of SVC according to a ninth exemplary embodiment consistent with the present invention.

### DESCRIPTION OF EMBODIMENTS

Consistent with the invention, there is provided a method for packing a bistream of Scalable Video Coding (SVC), and the method can be applied to increase smoothness of playing video and avoid a problem of video interruption caused by network congestion.

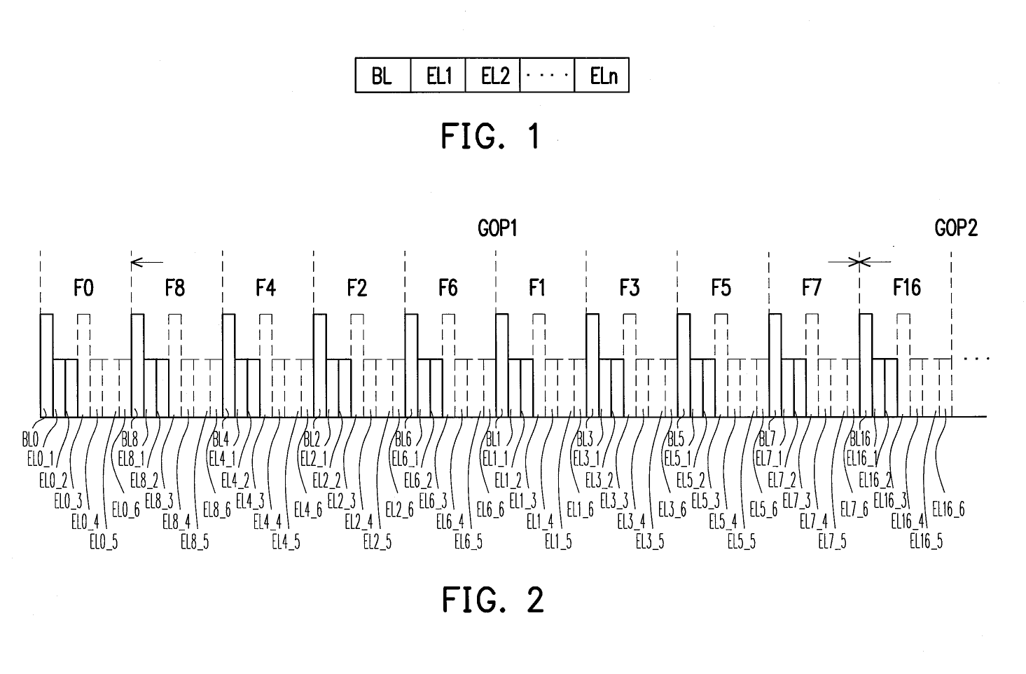

Regarding the bitstream of SVC, a plurality of frames of the bitstream can include a multi-layer architecture. For example, as shown in FIG. 1, each frame includes a base layer BL, a first enhancement layer EL1, a second enhancement layer EL2 . . . , and an nth enhancement layer ELn, wherein n is a positive integer. Besides, the number of the enhancement layers differs according to different video compression formats, and each of the layers (the base layer BL and the enhancement layers EL1˜ELn) has different resolutions, different frame rates, or different quality (for example, Signal to Noise Ratio, also abbreviated as SNR). In other words, complexity of the frames in each of the layers is recorded by different bitstream parameters.

The base layer BL generally at least includes the lowest resolution or the lowest frame rate. As a result, in a process of video decoding, a decoder at least needs to receive the base layer BL of the bitstream so as to proceed bitstream decoding and recover video frames back to their original states. Besides, the base layer BL along with the enhancement layers can ensure the bistream to have higher resolutions or higher frame rates. Furthermore, quality of the frames also increases on the condition of the base layer BL together with more enhancement layers. In addition, the above-described frames can constitute at least a Group of Pictures (GOP).

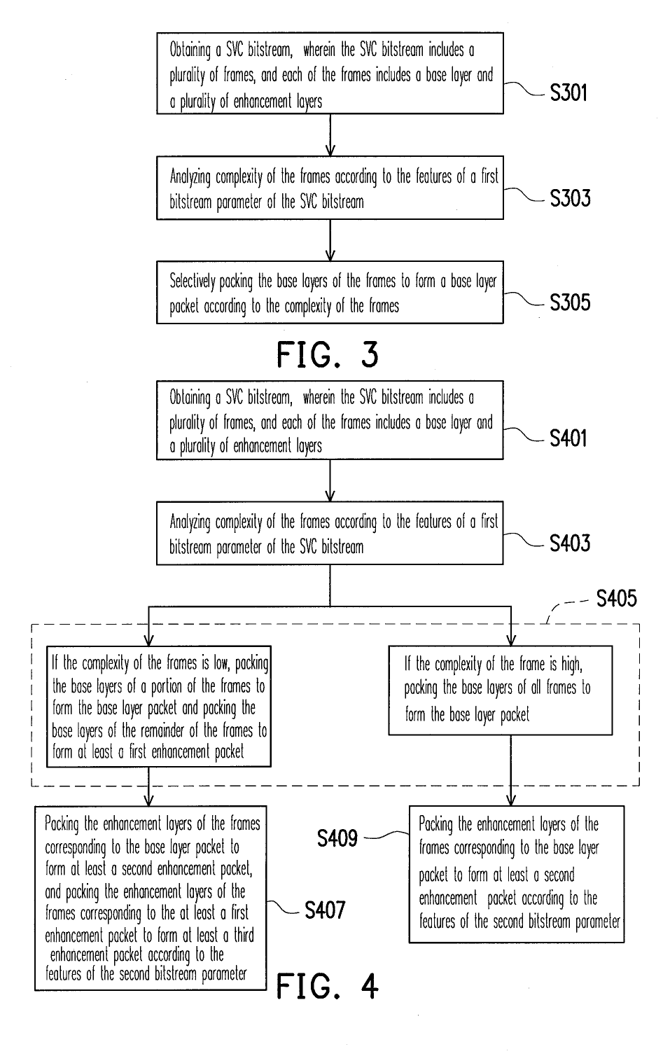

In the present embodiment as shown in FIG. 2, an SVC bitstream is encoded in a GOP of 8 frames for a convenience of explanation. Besides, Quarter Common Intermediate format (QCIF) and Common Intermediate format (CIF) are used in the above-described coding, for example. The resolution of the QCIF is 176 pixels by 144 pixels, and the resolution of the CIF is 352 pixels by 288 pixels.

Referring to FIG. 2, the bitstream includes frames F0, F1, F2, F3, F4, F5, F6, F7, F8, . . . Among all frames, BL0, BL2, BL3, BL4, BL5, BL6, BL7, BL8, . . . respectively refer to resolution perspective base layers-QCIF of the frames F0, F1, F2, F3, F4, F5, F6, F7, F8, . . . . Moreover, EL0_1, EL0_2, EL0_3, EL0_4, EL0_5, and EL0_6 respectively refer to the enhancement layers of the frame F0. EL0_1 and EL0_2 refer to the enhancement layers for supplementing BL0 quality (or SNR). EL0_3 refers to the enhancement layer (enhancing the BL0 resolution from QCIF to CIF) for supplementing BL0 resolution. In addition, EL0_4, EL0_5, and EL0_6 refer to the enhancement layers for supplementing EL0_3, quality (or SNR).

EL1_1, EL1_2, EL1_3, EL1_4, EL1_5, and EL1_6 respectively refer to the enhancement layers of the frame F1. EL1_1 and EL1_2 refer to the enhancement layers for supplementing BL1 quality (or SNR). EL1_3 refers to the enhancement layer (enhancing the BL1 resolution from QCIF to CIF) for supplementing BL1 resolution. In addition, EL1_4, EL1_5, and EL1_6 refer to the enhancement layers for supplementing EL1_3 quality (or SNR).

EL2_1, EL2_2, EL2_3, EL2_4, EL2_5, and EL2_6 respectively refer to the enhancement layers of the frame F2. EL2_1 and EL2_2 refer to the enhancement layers for supplementing BL2 quality (or SNR). EL2_3 refers to the enhancement layer (enhancing the BL2 resolution from QCIF to CIF) for supplementing BL2 resolution. In addition, EL2_4, EL2_5, and EL2_6 refer to the enhancement layers for supplementing EL2_3 quality (or SNR).

EL3_1, EL3_2, EL3_3, EL3_4, EL3_5, and EL3_6 respectively refer to the enhancement layers of the frame F3. EL3_1 and EL3_2 refer to the enhancement layers for supplementing BL3 quality (or SNR). EL3_3 refers to the enhancement layer (enhancing the BL3 resolution from QCIF to CIF) for supplementing BL3 resolution. In addition, EL3_4, EL3_5, and EL3_6 refer to the enhancement layers for supplementing EL3_3 quality (or SNR).

EL4_1, EL4_2, EL4_3, EL4_4, EL4_5, and EL4_6 respectively refer to the enhancement layers of the frame F4. EL4_1 and EL4_2 refer to the enhancement layers for supplementing BL4 quality (or SNR). EL4_3 refers to the enhancement layer (enhancing the BL4 resolution from QCIF to CIF) for supplementing BL4 resolution. In addition, EL4_4, EL4_5, and EL4_6 refer to the enhancement layers for supplementing EL4_3 Quality (or SNR).

EL5_1, EL5_2, EL5_3, EL5_4, EL5_5, and EL5_6 respectively refer to the enhancement layers of the frame F5. EL5_1 and EL5_2 refer to the enhancement layers for supplementing BL5 quality (or SNR). EL5_3 refers to the enhancement layer (enhancing the BL5 resolution from QCIF to CIF) for supplementing BL5 resolution. In addition, EL5_4, EL5_5, and EL5_6 refer to the enhancement layers for supplementing EL5_3 quality (or SNR).

EL6_1, EL6_2, EL6_3, EL6_4, EL6_5, and EL6_6 respectively refer to the enhancement layers of the frame F6. EL6_1 and EL6_2 refer to the enhancement layers for supplementing BL6 quality (or SNR). EL6_3 refers to the enhancement layer (enhancing the BL6 resolution from QCIF to CIF) for supplementing BL6 resolution. In addition, EL6_4, EL6_5, and EL6_6 refer to the enhancement layers for supplementing EL6_3 quality (or SNR).

EL7_1, EL7_2, EL7_3, EL7_4, EL7_5, and EL7_6 respectively refer to the enhancement layers of the frame F7. EL7_1 and EL7_2 refer to the enhancement layers for supplementing BL7 quality (or SNR). EL7_3 refers to the enhancement layer (enhancing the BL7 resolution from QCIF to CIF) for supplementing BL7 resolution. In addition, EL7_4, EL7_5, and EL7_6 refer to the enhancement layers for supplementing EL7_3 quality (or SNR).

EL8_1, EL8_2, EL8_3, EL8_4, EL8_5, and EL8_6 respectively refer to the enhancement layers of the frame F8. EL8_1 and EL8_2 refer to the enhancement layers for supplementing BL8 quality (or SNR). EL8_3 refers to the enhancement layer (enhancing the BL8 resolution from QCIF to CIF) for supplementing BL8 resolution. In addition, EL8_4, EL8_5, and EL8_6 refer to the enhancement layers for supplementing EL8_3 quality (or SNR).

In the present embodiment, the encoding technology of the frames of the bitstream uses a Hierarchical Prediction Structure (HPS), for example. However, the way of coding is not limited in the present embodiment. Moreover, a sequence of the frames after encoding of the frames of the bitstream is as follows: F0, F8, F4, F2, F6, F1, F3, F5, F7, . . . . In addition, in some embodiments, if the bistream is encoded in a GOP of 16 frames, then the sequence of the frames after encoding of the frames of the bitstream is as follows: F0, F16, F8, F4, F12, F2, F6, F10, F1, F3, F5, F7, F9, F11, F13, F15, . . . .

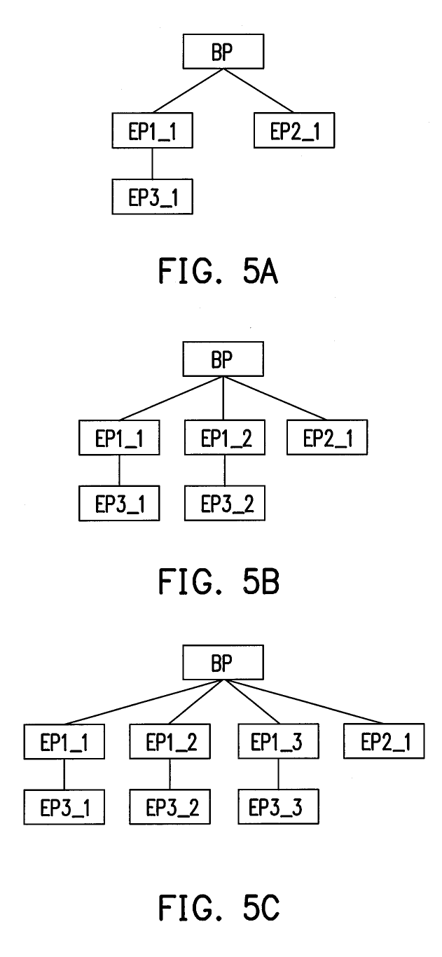

FIG. 3 shows a flowchart of a method for packing a bitstream of SVC according to one embodiment of the present invention. Please refer to both FIG. 2 and FIG. 3. First, in step S301, a SVC bitstream is obtained as shown in FIG. 2, wherein the SVC bistream includes a plurality of frames, and each of the frames includes a base layer and a plurality of enhancement layers.

In step S303, complexity of the frames is analyzed according to the features of a first bitstream parameter of the SVC bitstream. In the present embodiment, the above-described first bitstream parameter can be motion vector, and the motion vector is temporal scalable.

For instance, if the motion vector of the frames of the bitstream (e.g., news) is small, it means that the frames are considered as the frames of a lower motion rate (low frequency images) at the time of encoding. This also means that the motion rate of the frames is lower (the complexity of the frames is lower). In other words, if the motion vector of the frames of the bitstream (for example, frames of an American football game) is large, it means that the frames are considered as the frames of a higher motion rate (high frequency images) at the time of encoding. This also means that the motion rate of the frames is higher (the complexity of the frames is higher).

In step S305, according to the complexity of the frames, the base layers of the frames are selectively packed to form a base layer packet. For example, if the frames are analyzed as simple (i.e., the motion vector is small), the resolution perspective base layers-QCIF BL0, BL8, BL16, BL24, . . . of the frames F0, F8, F16, F24, . . . are packed to form the base layer packet BP. This also means the base layers of a portion of the frames are packed to form the base layer packet BP. On the other hand, if the frames are analyzed as complicated (i.e., the motion vector is large), the resolution perspective base layers-QCIF BL0, BL8, BL4, BL2, BL6, BL1, BL3, BL5, BL7, . . . of the frames F0, F8, F4, F2, F6, F1, F3, F5, F7, . . . are packed to form the base layer packet BP. This also means the base layers of all of the frames are packed to form the base layer packet BP.

Then, when the base layer packet BP in the two forms described above is placed in a network (a general network or a heterogeneous network), a user may download the base layer packet BP in which the base layers of a portion of the base layer are packed or the base layer packet BP in which the base layers of all frames are packed according to the network bandwidth, and further make the decoder proceed analysis so as to watch video. Since the base layer packet BP includes the base layers of the frames (for example, including the base layer capable of playing 200 seconds of frames), there is no interruption when the user watches video frame (for example, the frame at the 100^{th} second) and plays the video frame forwards (for example, playing the frame at the 150^{th} second) or plays the video frame backwards (for example, playing the frame at the 50^{th} second). Hence, according to the present embodiment, smoothness of playing the frames (the video) can be increased, and a phenomenon of image interruption caused by insufficient bandwidth can be avoided.

In the above-described embodiment, only descriptions of packing the base layer packet BP are provided; however, the embodiment is not limited to the descriptions. In addition to forming the base layer packet BP by packing, the enhancement packet can also be formed by packing according to other bitstream parameters of the SVC bitstream, so as to increase the frame quality. In order to make people having ordinary skill in the art understand the method for packing the bitstream of SVC in the present embodiment, another exemplary embodiment is provided below for further explanation.

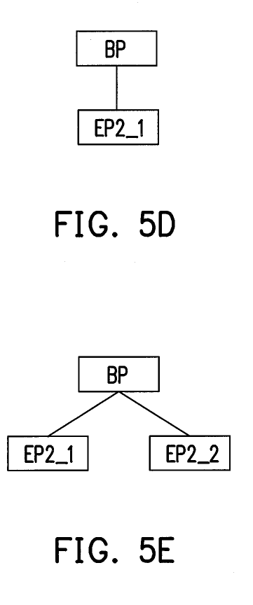

FIG. 4 shows a flowchart of a method for packing a bitstream of SVC according to one embodiment of the present invention. Referring to both FIG. 2 and FIG. 4, steps S401, S403, and S405 of FIG. 4 can be referred to as the steps S301, S303, and S305 of FIG. 3, and therefore detailed descriptions associated with the steps S401, S403, and S405 are not provided herein.

In step S405, if complexity of the frames is low (i.e., the motion vector is small), then pack the base layers of a portion of the frames to form the base layer packet BP, and the base layers of the remainder of the frames are packed to form at least a first enhancement packet, wherein the at least a first enhancement packet includes at least a frame data estimated from a key picture. In the present embodiment, the key picture is F0.

For example, when the base layer packet BP includes the resolution perspective base layers-QCIF BL0, BL8, BL16, . . . of the frames F0, F8, F16, . . . , there is one first enhancement packet, and this means that the first enhancement packet EP1_1 includes the resolution perspective base layers-QCIF BL4, BL2, BL6, BL1, BL3, BL5, BL7, . . . of the frames F4, F2, F6, F1, F3, F5, F7, . . . . In some embodiments, there can be two first enhancement packets, which means that the first enhancement packet EPL_1 includes the resolution perspective base layers-QCIF BL4, BL2, BL6, . . . of the frames F4, F2, F6, . . . , and the first enhancement packet EP1_2 includes the resolution perspective base layers-QCIF BL1, BL3, BL5, BL7, . . . of the frames F1, F3, F5, F7, . . . . Alternatively, there may be three first enhancement packets, and this means that the first enhancement packet EP1_1 includes the resolution perspective base layers-QCIF BL4, . . . of the frames F4, . . . , the first enhancement packet EP1_2 includes the resolution perspective base layers-QCIF BL2, BL6, . . . of the frames F2, F6, . . . , and the first enhancement packet EP1_3 includes the resolution perspective base layers-QCIF BL1, BL3, BL5, BL7, . . . of the frames F1, F3, F5, F7, . . . .

It is to be noted that if the bitstream is encoded in a GOP of 16 frames, then the frame sequence after the encoding is as follows: F0, F16, F8, F4, F12, F2, F6, F10, F14, F1, F3, F5, F7, F9, F13, F15, . . . . (not shown). When the base layer packet BP includes the resolution perspective base layers-QCIF BL0, BL16, BL32, . . . of the frames F0, F16, F32, . . . , there is one first enhancement packet, and this means that the first enhancement packet EP1_1 includes the resolution perspective base layers-QCIF BL8, BL4, BL12, BL2, BL6, BL10, BL14, BL1, BL3, BL5, BL7, BL9, BL11, BL13, BL15, . . . of the frames F8, F4, F12, F2, F6, F10, F14, F1, F3, F5, F7, F9, F11, F13, 15, . . . .

In some embodiments, there may be two first enhancement packets, which means that the first enhancement packet EP1_1 includes the resolution perspective base layers-QCIF BL8, BL4, BL12, BL2, BL6, BL10, BL14, . . . of the frames F8, F4, F12, F2, F6, F10, F14, . . . , and the first enhancement packet EP1_2 includes the resolution perspective base layers-QCIF BL1, BL3, BL5, BL7, BL9, BL11, BL13, BL15, . . . of the frames F1, F3, F5, F7, F9, F11, F13, F15, . . . . Alternatively, there may be three first enhancement packets, which means that the first enhancement packet EP1_1 includes the resolution perspective base layers-QCIF BL8, BL4, BL12, . . . of the frames F8, F4, F12, . . . , the first enhancement packet EP1_2 includes the resolution perspective base layers-QCIF BL2, BL6, BL10, BL14, . . . of the frames F2, F6, F10, F14, . . . , and the first enhancement packet EP1_3 includes the resolution perspective base layers-QCIF BL1, BL3, BL5, BL7, BL9, BL11, BL13, BL15, . . . of the frames F1, F3, F5, F7, F9, F11, F13, F15, . . . . Alternatively, there may be four first enhancement packets, which means that the first enhancement packet EP1_1 includes the resolution perspective base layers-QCIF BL8, . . . of the frames F8, . . . , the first enhancement packet EP1_2 includes the resolution perspective base layers-QCIF BL4, BL12, . . . of the frames F4, F12, F12, . . . , the first enhancement packet EP1_3 includes the resolution perspective base layers-QCIF BL2, BL6, BL10, BL14, . . . of the frames F2, F6, F10, F14, . . . , and the first enhancement packet EP1_4 includes the resolution perspective base layers-QCIF BL1, BL3, BL5, BL7, BL9, BL11, BL13, BL15, . . . of the frames F1, F3, F5, F7, F9, F11, F13, F15, . . . .

In step S407, according to the features of a second bitstream parameter, the enhancement layers of the frames corresponding to the base layer packet BP are packed to form at least a second enhancement packet, and the enhancement layers of the frames corresponding to the at least a first enhancement packet are packed to form at least a third enhancement packet. In the embodiment, the second bitsteram parameter is either Quatization Parameter (QP) or Block Size (BS). The QP corresponds to SNR scalability. If the QP is small, a bit rate of the bitstream is low, and then this section of the bitstream can be packed to form an enhancement packet during packing without dividing the bitstream to a plurality of enhancement packets. On the contrary, if the QP is large, the bit rate of the bitstream is high, so it is required to have this section of the bitstream packed to form a plurality of enhancement packets for fear of losing too much video content when each time the network bandwidth varies.

The BS corresponds to spatial scalability. If the BS is large, the picture is monotone, so this section of the bitstream can be packed to form an enhancement packet without dividing the bitstream to a plurality of enhancement packets. On the contrary, if the BS is small, the picture is fine, so it is required to pack the section of the bitstream to form a plurality of enhancement packets for fear of losing too much video content when each time the network bandwidth varies.

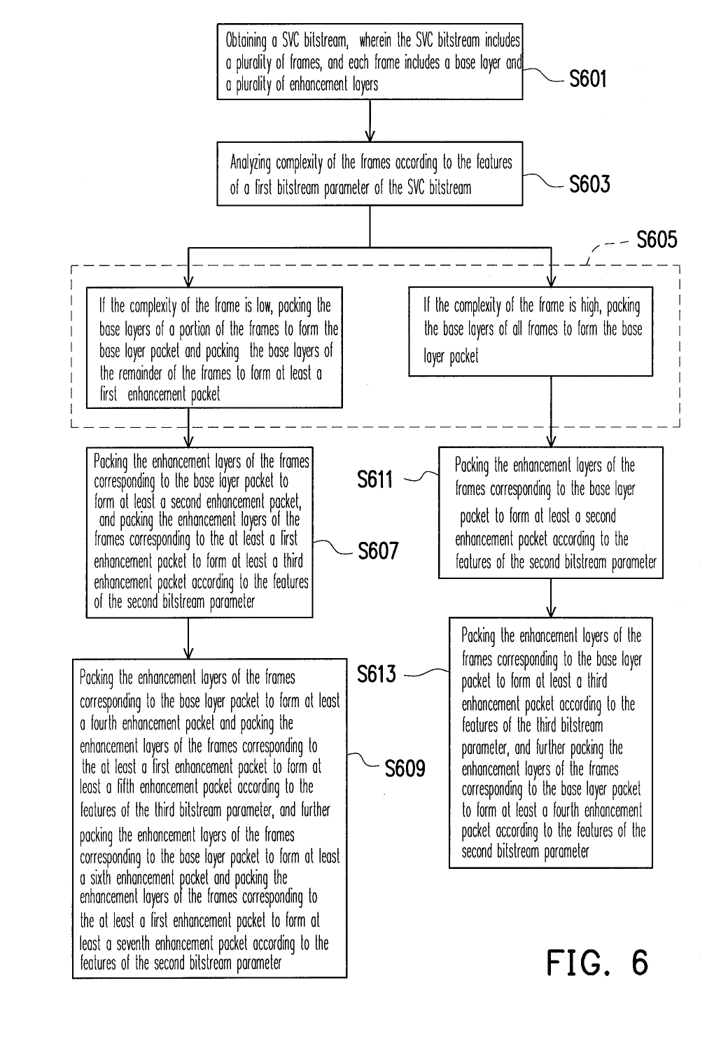

For example, referring to FIG. 5A for a schematic diagram illustrating a result of a method for packing a bitstream of SVC according to a first embodiment, if the base layer packet BP includes the resolution perspective base layers-QCIF BL0, BL8, BL16, . . . of the frames F0, F8, F16, . . . , the first enhancement packet EP1_1 includes the resolution perspective base layers-QCIF BL4, BL2, BL6, BL1, BL3, BL5, BL7, . . . of the frames F4, F2, F6, F1, F3, F5, F7, . . . , the second enhancement packet EP2_1 includes the enhancement layers EL0_1, EL0_2, EL0_3, EL0_4, EL0_5, EL0_6, EL8_1, EL8_2, EL8_3, EL8_4, EL8_5, EL8_6, EL16_1, EL16_2, EL16_3, EL16_4, EL16_5, EL16_6, . . . of the frames F0, F8, F16, . . . , and the third enhancement packet EP3_1 includes the enhancement layers EL4_1, EL4_2, EL4_3, EL4_4, EL4_5, EL4_6, EL2_1, EL2_2, EL2_3, EL2_4, EL2_5, EL2_6, EL6_1, EL6_2, EL6_3, EL6_4, EL6_5, EL6_6, EL1_1, EL1_2, EL1_3, EL1_4, EL1_5, EL1_6, EL3_1, EL3_2, EL3_3, EL3_4, EL3_5, EL3_6, EL5_1, EL5_2, EL5_3, EL5_4, EL5_5, EL5_6, EL7_1, EL7_2, EL7_3, EL7_4, EL7_5, EL7_6, . . . of the frames F4, F2, F6, F1, F3, F5, F7, . . . .

Besides, referring to FIG. 5B for a schematic diagram describing a result of a method for packing a bitstream of SVC of a second embodiment, if the base layer packet BP includes the resolution perspective base layers-QCIF BL0, BL8, BL16, . . . of the frames F0, F8, F16, . . . , the first enhancement packet EP1_1 includes the resolution perspective base layers-QCIF BL4, BL2, BL6, . . . of the frames F4, F2, F6, . . . , the first enhancement packet EP1_2 includes the resolution perspective base layers-QCIF BL1, BL3, BL5, BL7, . . . of the frames F1, F3, F5, F7, . . . , the second enhancement packet EP2_1 includes the enhancement layers EL0_1, EL0_2, EL0_3, EL0_4, EL0_5, EL0_6, EL8_1, EL8_2, EL8_3, EL8_4, EL8_5, EL8_6, EL16_1, EL16_2, EL16_3, EL16_4, EL16_5, EL16_6, . . . of the frames F0, F8, F16, . . . , the third enhancement packet EP3_1 includes the enhancement layers EL4_1, EL4_2, EL4_3, EL4_4, EL4_5, EL4_6, EL2_1, EL2_2, EL2_3, EL2_4, EL2_5, EL2_6, EL6_1, EL6_2, EL6_3, EL6_4, EL6_5, EL6_6, . . . of the frames F4, F2, F6, . . . , and the third enhancement packet EP3_2 includes the enhancement layers EL1_1, EL1_2, EL1_3, EL1_4, EL1_5, EL1_6, EL3_1, EL3_2, EL3_3 EL3_4, EL3_5, EL3_6, EL5_1, EL5_2, EL5_3, EL5_4, EL5_5, EL5_6, EL7_1, EL7_2, EL7_3, EL7_4, EL7_5, EL7_6, . . . . of the frames F1, F3, F5, F7, . . . .

Moreover, referring to FIG. 5C for describing a schematic diagram of a result of a method for packing a bitstream of SVC of a third embodiment, if the base layer packet BP includes the resolution perspective base layers-QCIF BL0, BL8, BL16, . . . of the frames F0, F8, F16, . . . , the first enhancement packet EP1_1 includes the resolution perspective base layers-QCIF BL4, . . . of the frames F4, . . . , the first enhancement packet EP1_2 includes resolution perspective base layers-QCIF BL2, BL6, . . . of the frames F2, F6, . . . , the first enhancement packet EP1_3 includes the resolution perspective base layers-QCIF BL1, BL3, BL5, BL7, . . . of the frames F1, F3, F5, F7, . . . . and the second enhancement packet EP2_1 includes EL1_1, EL1_2, EL1_3, EL1_4, EL1_5, EL1_6, EL8_1, EL8_2, EL8_3, EL8_4, EL8_5, EL8_6, EL16_1, EL16_2, EL16_3, EL16_4, EL16_5, EL16_6, . . . of the frames F0, F8, F16, . . . . Furthermore, the third enhancement packet EP3_1 includes the enhancement layers EL4_1, EL4_2, EL4_3, EL4_4, EL4_5, EL4_6, . . . of the frames F4, . . . , the third enhancement packet EP3_2 includes the enhancement layers EL2_1, EL2_2, EL2_3, EL2_4, EL2_5, EL2_6, EL6_1, EL6_2, EL6_3, EL6_4, EL6_5, EL6_6, . . . of the frames F2, F6, . . . , and the third enhancement packet EP3_3 includes the enhancement layers EL1_1, EL1_2, EL1_3, EL1_4, EL1_5, EL1_6, EL3_1, EL3_2, EL3_3, EL3_4, EL3_5, EL3_6, EL5_1, EL5_2, EL5_3, EL5_4, EL5_5, EL5_6, EL7_1, EL7_2, EL7_3, EL7_4, EL7_5, EL7_6, . . . of the frames F1, F3, F5, F7, . . . .

In addition, the way to pack the second enhancement packet encoded in a GOP of 16 frames and the third enhancement packet can refer to the description of the above-described encoding of the GOP of 16 frames. Therefore, detailed descriptions of the way to pack the second enhancement packet encoded in a GOP of 16 frames and the third enhancement packet will not be provided herein.

Next, when the above-described base layer packet BP, the first enhancement packets, the second enhancement packets, and the third enhancement packets are placed in a network (a general network or a heterogeneous network), a user can choose the type of the base layer packet (the base layer packet in which the base layers of a portion of frames are packed or the base layer packet in which the base layers of all of the frames are packed) according to the network bandwidth and decide to download the same, so as to watch video continuously without being interrupted. Since the base layer packet has the frames with the lowest resolution and the lowest frame rate, if there is a redundant bandwidth, the first enhancement packets, the second enhancement packets, and the third enhancement packets may be downloaded to enhance picture quality of video playing.

On the other hand, in step S405, if the frames are deemed complicated, then the base layers of all of the frames are packed to form the base layer packet BP. For example, the base layer packet BP includes the resolution perspective base layers-QCIF BL0, BL8, BL4, BL2, BL6, BL1, BL3, BL5, BL7, BL16, . . . of the frames F0, F8, F4, F2, F6, F1, F3, F5, F7, F16, . . . .

In step S409, according to the features of the second bitstream parameter (QP or BS), the enhancement layers of the frames corresponding to the base layer packet are packed to form at least a second enhancement packet. For example, referring to FIG. 5 for a schematic diagram illustrating a result of packing a bitstream of SVC according to the fourth embodiment, there can be one second enhancement packet EP2_1, and this means that the second enhancement packet EP2_1 includes the enhancement layers EL0_1, EL0_2, EL0_3, EL0_4, EL0_5, EL0_6, EL8_1, EL8_2, EL8_3, EL8_4, EL8_5, EL8_6, EL4_1, EL4_2, EL4_3, EL4_4, EL4_5, EL4_6, EL2_1, EL2_2, EL2_3, EL2_4, EL2_5, EL2_6, EL6_1, EL6_2, EL6_3, EL6_4, EL6_5, EL6_6, EL1_1, EL1_2, EL1_3, EL1_4, EL1_5, EL1_6, EL3_1, EL3_2, EL3_3, EL3_4, EL3_5, EL3_6, EL5_1, EL5_2, EL5_3, EL5_4, EL5_5, EL5_6, EL7_1, EL7_2, EL7_3, EL7_4, EL7_5, EL7_6, EL16_1, EL16_2, EL16_3, EL16_4, EL16_5, EL16_6, . . . of the frames F0, F8, F4, F2, F6, F1, F3, F5, F7, F16, . . . .

In some embodiments, there may be two or more enhancement packets EP2_1. For example, referring to FIG. 5 for a schematic diagram illustrating a result of packing a bitstream of SVC according to a fifth embodiment, if there are two second enhancement packets, i.e. the second enhancement packet EP2_1 includes the enhancement layers EL0_1, EL0_2, EL8_1, EL8_2, EL4_1, EL4_2, EL2_1, EL2_2, EL6_1, EL6_2, EL1_1, EL1_2, EL3_1, EL3_2, EL5_1, EL5_2, EL7_1, EL7_2, EL16_1, EL16_2, . . . of the frames F0, F8, F4, F2, F6, F1, F3, F5, F7, F16, . . . , and the second enhancement packet EP2_2 includes the enhancement layers EL0_3, EL0_4, EL0_5, EL0_6, EL8_3, EL8_4, EL8_5, EL8_6, EL4_3, EL4_4, EL4_5, EL4_6, EL2_3, EL2_4, EL2_5, EL2_6, EL6_3, EL6_4, EL6_5, EL6_6, EL1_3, EL1_4, EL1_5, EL1_6, EL3_3, EL3_4, EL3_5, EL3_6, EL5_3, EL5_4, EL5_5, EL5_6, EL7_3, EL7_4, EL7_5, EL7_6, EL16_3, EL16_4, EL16_5, EL16_6, . . . of the frames F0, F8, F4, F2, F6, F1, F3, F5, F7, F16, . . . .

Other ways to form the second enhancement packet by packing can refer to previous descriptions, and therefore further detailed descriptions are not provided herein.

Next, when the above-described base layer packet, the first enhancement packet, the second enhancement packet, and the third enhancement packet are placed in a network, a user can decide whether to download the enhancement packet, the second enhancement packet, and the third enhancement packet after the base layer packet is received, so as to enhance picture quality of video playing.

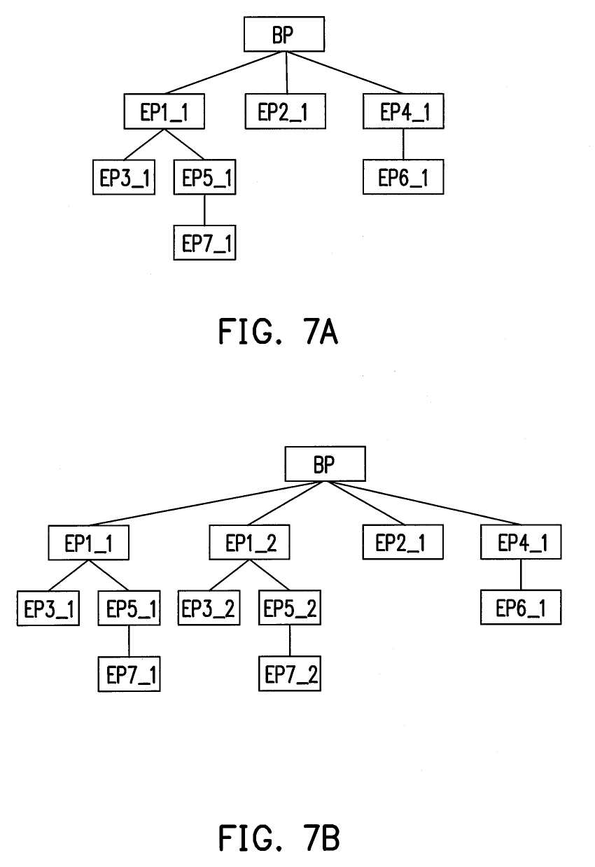

FIG. 6 shows a flowchart of a method for packing a bitstream of SVC according to one embodiment of the present invention. Referring to both FIG. 6 and FIG. 2, and steps S601, S603, and S605 of FIG. 6 can refer to the steps S401, S403, and S405 of FIG. 4. Therefore, relevant detailed descriptions are not further provided herein.

Next, in step S605, if the complexity of the frames is low (i.e., MV is small), then the base layers of a portion of frames are packed to form the base layer packet BP, and the base layers of the remainder of the frames are packed to form at least a first enhancement packet, wherein the at least a first enhancement packet at least includes a data frame estimated from a key picture. In the embodiment, the key picture is the frame F0.

For example, the base layer packet BP includes the resolution perspective base layers-QCIF BL0, BL8, BL16, . . . of the frames F0, F8, F16 . . . . There may be one first enhancement packet, and this means that the first enhancement packet EP1_1 includes the resolution perspective base layers-QCIF BL4, BL2, BL6, BL1, BL3, BL5, BL7, . . . of the frames F4, F2, F6, F1, F3, F5, F7, . . . . In some embodiments, there may be two first enhancement packets, and this means that the first enhancement packet EP1_1 includes the resolution perspective base layers-QCIF BL4, BL2, BL6, . . . of the frames F4, F2, F6, . . . , and the first enhancement packet EP1_2 includes the resolution perspective base layers-QCIF BL1, BL3, BL5, BL7, . . . of the frames F1, F3, F5, F7, . . . . Alternatively, there may be three first enhancement packets, and this means that the first enhancement packet EP1_1 includes the resolution perspective base layers-QCIF BL4, . . . of the frames F4, . . . , the first enhancement packet EP1_2 includes the resolution perspective base layers-QCIF BL2, BL6, . . . of the frames F2, F6, . . . , and the first enhancement packet EP1_3 includes the resolution perspective base layers-QCIF BL1, BL3, BL5, BL7, . . . of the frames F1, F3, F5, F7, . . . .

In step S607, according to the features of the second bitstream parameters, the enhancement layers of the frames corresponding to the base layer packet are packed to form at least a second enhancement packet, and the enhancement layers of the frames corresponding to the at least a first enhancement packet are packed to form at least a third enhancement packet. In step S609, according to the features of the third bitstream parameters, the enhancement layers of the frames corresponding to the base layer packet are packed to form at least a fourth enhancement packet, and the enhancement layers of the frames corresponding to the at least a first enhancement packet are packed to form at least a fifth enhancement packet. Moreover, according to the features of the second bitstream parameters, the enhancement layers of the frames corresponding to the base layer packet are packed to form at least a sixth enhancement packet, and the enhancement layers of the frames corresponding to the at least a first enhancement packet are packed to form at least a seventh enhancement packet. In the embodiment, the second bitstream parameter and the third bitstream parameter are one of quantization parameter and block size respectively, and the second bitstream parameter and the third bitstream parameter are different from each other. The enhancement packets that are packed according to the features of the second bitstream parameter and the third bitstream parameter can be utilized to enhance the picture quality.

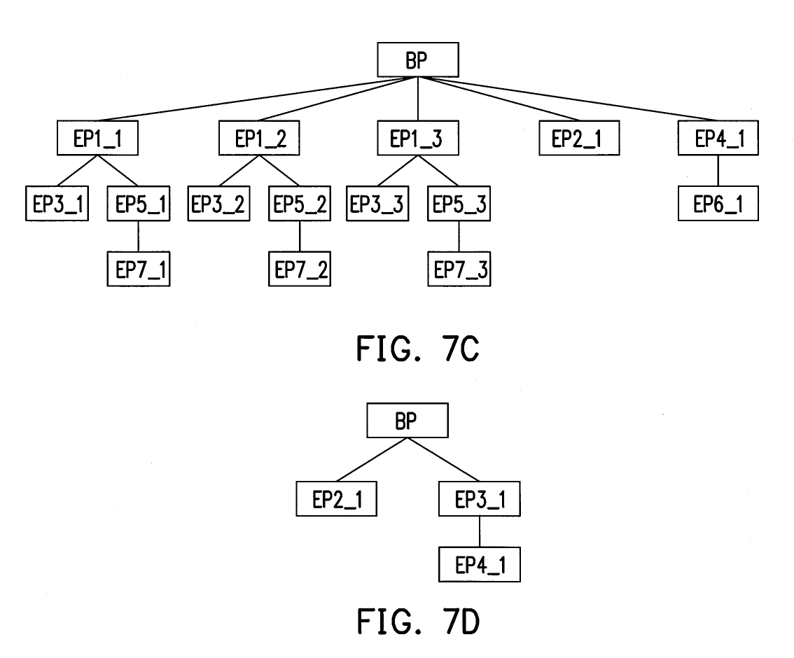

For instance, referring to FIG. 7A for a schematic diagram illustrating a result of packing a bitstream of SVC according to a sixth embodiment, if the base layer packet BP includes the resolution perspective base layers-QCIF BL0, BL8, BL16, . . . of the frames F0, F8, F16, . . . , the first enhancement packet EP1_1 includes the resolution perspective base layers-QCIF BL4, BL2, BL6, BL1, BL3, BL5, BL7, . . . of the frames F4, F2, F6, F1, F3, F5, F7, . . . , and the second enhancement packet EP2_1 includes the enhancement layers EL0_1, EL0_2, EL8_1, EL8_2, EL16_1, EL16_2, . . . of the frames F0, F8, F16, . . . .

The third enhancement packet EP3_1 includes the enhancement layers EL4_1, EL4_2, EL2_1, EL2_2, EL6_1, EL6_2, EL1_1, EL1_2, EL3_1, EL3_2, EL5_1, EL5_2, EL7_1, EL7_2, . . . of the frames F4, F2, F6, F1, F3, F5, F7, . . . . The fourth enhancement packet EP4_1 includes the enhancement layers EL0_3, EL8_3, EL16_3, . . . of the frames F0, F8, F16, . . . .

The fifth enhancement packet EP5_1 includes the enhancement layers EL4_3, EL2_3, EL6_3, EL1_3, EL3_3, EL5_3, EL7_3, . . . of the frames F4, F2, F6, F1, F3, F5, F7, . . . . The sixth enhancement packet EP6_1 includes the enhancement layers EL0_4, EL0_5, EL0_6, EL8_4, EL8_5, EL8_6, EL16_4, EL16_5, EL16_6, . . . of the frames F0, F8, F16, . . . .

The seventh enhancement packet EP7_1 includes the enhancement layers EL4_4, EL4_5, EL4_6, EL2_4, EL2_5, EL2_6, EL6_4, EL6_5, EL6_6, EL1_4, EL1_5, EL1_6, EL3_4, EL3_5, EL3_6, EL5_4, EL5_5, EL5_6, EL7_4, EL7_5, EL4_6, . . . of the frames F4, F2, F6, F1, F3, F5, F7, . . . .

Besides, referring to FIG. 7B for a schematic diagram illustrating a result of packing a bitstream of SVC according to a seventh embodiment, if the base layer packet BP includes the resolution perspective base layers-QCIF BL0, BL8, BL16, . . . of the frames F0, F8, F16, . . . , the first enhancement packet EP1_1 includes the resolution perspective base layers-QCIF BL4, BL2, BL6, . . . of the frames F4, F2, F6, . . . , the first enhancement packet EP1_2 includes the resolution perspective base layers-QCIF BL1, BL3, BL5, BL7, . . . of the frames F1, F3, F5, F7, . . . , and the second enhancement packet EP2_1 includes the enhancement layers EL0_1, EL0_2, EL8_1, EL8_2, EL16_1, EL16_2, . . . of the frames F0, F8, F16, . . . . The third enhancement packet EP3_1 includes the enhancement layers EL4_1, EL4_2, EL2_1, EL2_2, EL6_1, EL6_2, . . . of the frames F4, F2, F6, . . . , and the third enhancement packet EP3_2 includes the enhancement layers EL1_1, EL1_2, EL3_1, EL3_2, EL5_1, EL5_2, EL7_1, EL7_2, ofthe frames F0, F8, F16, . . . .

The fourth enhancement packet EP4_1 includes the enhancement layers EL0_3, EL8_3, EL16_3, . . . of the frames F0, F8, F16, . . . , and the fifth enhancement packet EP5_1 includes the enhancement layers EL1_3, EL3_3, EL5_3, EL7_3, . . . of the frames F1, F3, F5, F7, . . . .

The sixth enhancement packet EP6_1 includes the enhancement layers EL0_4, EL0_5, EL0_6, EL8_4, EL8_5, EL8_6, EL16_4, EL16_5, EL16_6, . . . of the frames F0, F8, F16, . . . . The seventh enhancement packet EP7_1 includes the enhancement layers EL4_4, EL4_5, EL4_6, EL2_4, EL2_5, EL2_6, EL6_4, EL6_5, EL6_6, . . . of the frames F4, F2, F6, . . . . The seventh enhancement packet EP7_2 includes the enhancement layers EL1_4, EL1_5, EL1_6, EL3_4, EL3_5, EL3_6, EL5_4, EL5_5, EL5_6, EL7_4, EL7_5, EL7_6, . . . of the frames F1, F3, F5, F7, . . . .

Next, referring to FIG. 7C for a schematic diagram illustrating a result of packing a bitstream of SVC according to an eighth embodiment, if the base layer packet BP includes the resolution perspective base layers-QCIF of the BL0, BL8, BL16, . . . of the frames F0, F8, F16, . . . , the first enhancement packet EP1_1 includes the base layers-QCIF of the resolution perspective BL4, . . . of the frames F4, . . . , the first enhancement packet EP1_2 includes the base layers-QCIF of the resolution perspective BL2, BL6, . . . of the frames F2, F6, . . . , the first enhancement packet EP1_3 includes the base layers-QCIF of the resolution perspective BL1, BL3, BL5, BL7, . . . of the frames F1, F3, F5, F7, . . . , and the second enhancement packet EP2_1 includes the enhancement layers EL0_1, EL0_2, EL8_1, EL8_2, EL16_1, EL16_2, . . . of the frames F0, F8, F16, . . . .

The third enhancement packet EP3_1 includes the enhancement layers EL4_1, EL4_2, . . . of the frames F4, . . . . The third enhancement packet EP3_2 includes the enhancement layers EL2_1, EL2_2, EL6_1, EL6_2, . . . of the frames F2, F6, . . . . The third enhancement packet EP3_3 includes the enhancement layers EL1_1, EL1_2, EL3_1, EL3_2, EL5_1, EL5_2, EL7_1, EL7_2, . . . of the frames F1, F3, F5, F7, . . . .

The fourth enhancement packet EP4_1 includes enhancement layers EL0_3, EL8_3, EL16_3, . . . of the frames F0, F8, F16, . . . .

The fifth enhancement packet EP5_1 includes enhancement layers EL4_3, . . . of the frames F4, . . . . The fifth enhancement packet EP5_2 includes enhancement layers EL2_3, EL6_3, . . . of the frames F2, F6, . . . . The fifth enhancement packet EP5_3 includes enhancement layers EL1_3, EL3_3, EL5_3, EL7_3, . . . of the frames F1, F3, F5, F7, . . . .

The sixth enhancement packet EP6_1 includes enhancement layers EL0_4, EL0_5, EL0_6, EL8_4, EL8_5, EL8_6, EL16_4, EL16_5, EL16_6, . . . of the frames F0, F8,F16 . . . .

The seventh enhancement packet EP7_1 includes enhancement layers EL4_4, EL4_5, EL4_6, . . . of the frames F4, . . . . The seventh enhancement packet EP7_2 includes enhancement layers EL2_4, EL2_5, EL2_6, EL6_4, EL6_5, EL6_6, . . . of the frames F2, F6, . . . . The seventh enhancement packet EP7_3 includes enhancement layers EL1_4, EL1_5, EL1_6, EL3_4, EL3_5, EL3_6, EL5_4, EL5_5, EL5_6, EL7_4, EL7_5, EL7_6, . . . of the frames F1, F3, F5, F7, . . . .

Next, the above-described packets are placed in a network, and a user may choose required types of packets according to the network bandwidth, so as to watch video continuously without being interrupted.

On the other hand, in step S605, if the complexity of the frames is high, then the base layers of all of the frames are packed to form the base layer packets. For example, the base layer packet BP includes the base layers-QCIF of the resolution perspective BL0, BL8, BL4, BL2, BL6, BL1, BL3, BL5, BL7, BL16, . . . of the frames F0, F8, F4, F2, F6, F1, F3, F5, F7, F16, . . . .

Next, in step S611, according to the features of the second bitstream parameter, the enhancement layers of the frames corresponding to the base layer packet are packed to form at least a second enhancement packet. Next, in step S613, according to the features of the third bitstream parameter, the enhancement layers of the frames corresponding to the base layer packet are packed to form at least a third enhancement packet, and further according to the features of the second bitstream parameter, the enhancement layers of the frames corresponding to the base layer packet are packed to form at least a fourth enhancement packet.

For example, referring to FIG. 7D for a schematic diagram illustrating a result of packing a bitstream of SVC according to a ninth embodiment, the second enhancement packet EP2_1 includes enhancement layers EL0_1, EL0_2, EL8_1, EL8_2, EL4_1, EL4_2, EL2_1, EL2_2, EL6_1, EL6_2, EL1_1, EL1_2, EL3_1, EL3_2, EL5_1, EL5_2, EL7_1, EL7_2, EL16_1, EL16_2, . . . of the frames F0, F8, F4, F2, F6, F1, F3, F5, F7, F16, . . . .

The third enhancement packet EP3_1 includes enhancement layers EL0_3, EL8_3, EL4_3, EL2_3, EL6_3, EL1_3, EL3_3, EL5_3, EL7_3, EL16_3, . . . of the frames F0, F8, F4, F2, F6, F1, F3, F5, F7, F16, . . . . The fourth enhancement packet EP4_1 includes enhancement layers EL0_4, EL0_5, EL0_6, EL8_4, EL8_5, EL8_6, EL4_4, EL4_5, EL4_6, EL2_4, EL2_5, EL2_6, EL6_4, EL6_5, EL6_6, EL1_4, EL1_5, EL1_6, EL3_4, EL3_5, EL3_6, EL5_4, EL5_5, EL5_6, EL7_4, EL7_5, EL7_6, EL16_4, EL16_5, EL16_6, . . . of the frames F0, F8, F4, F2, F6, F1, F3, F5, F7, F16, . . . .

Next, when the above-described packets are placed in a network, a user may download the required types of the base layer packets (the base layer packets in which the base layers of a portion of frames are packed or the base layer packets in which the base layers of all of the frames are packed) to play video frames according to the network bandwidth so as to watch video continuously without being interrupted. Next, if there is a redundant bandwidth, the user may have the picture quality of video playing (i.e., the resolution of the frames) enhanced by downloading the first enhancement packets, the second enhancement packets, and so on.

In summary, according to the above-described embodiments, the base layers are selectively packed to form the base layer packet (i.e., packing the base layers of all of the frames to form the base layer packets or packing the base layers of a portion of frames to form a base layer packet) according to the features of the bitstream parameter of the SVC bitstream. Hence, with limited bandwidth, smoothness of frames which are played can be enhanced (i.e., no video interruption caused by network congestion). In addition, the base layers which are not packed to form the base layer packet and the enhancement layers in the frames are respectively packed to form at least a first enhancement packet and at least a second enhancement packet so as to achieve better picture quality when there is a redundant bandwidth. Therefore, strong adaptability is produced due to fine packing of the video streaming when network environments and video receiver devices are diverse.

Though the present invention has been disclosed above by the embodiments, they are not intended to limit the present invention. Anybody skilled in the art can make some modifications and variations without departing from the spirit and scope of the present invention. Therefore, the protecting range of the present invention falls in the appended claims.

What is claimed is:

1. A method for packing a bitstream of scalable video coding (SVC), the method comprising:
obtaining a SVC bitstream, wherein the SVC bitstream comprises a plurality of frames, and each of the frames comprises a base layer and a plurality of enhancement layers;
analyzing complexity of the frames according to the features of a first bitstream parameter of the SVC bitstream; and
selectively packing the base layers of the frames to form a base layer packet according to the complexity of the frames.

2. The method for packing the bitstream of SVC as claimed in claim 1, wherein the first bitstream parameter is motion vector.

3. The method for packing the bitstream of SVC as claimed in claim 1, wherein the step of selectively packing the base layers of the frames to form the base layer packet according to the complexity of the frames comprises:
packing the base layers of a portion of the frames to form the base layer packet and packing the base layers of the remainder of the frames to form at least a first enhancement packet if the complexity of the frames is low, wherein the at least a first enhancement packet comprises at least a frame data estimated from a key picture; and
packing the base layers of all of the frames to form the base layer packet if the complexity of the frame is high

4. The method for packing the bitstream of SVC as claimed in claim 3, wherein the SVC bitstream further comprises a second bitstream parameter, and the step of packing the base layers of the portion of the frames to form the base layer packet and packing the base layers of the remainder of the frames to form the at least a first enhancement packet further comprising:
packing the enhancement layers of the frames corresponding to the base layer packet to form at least a second enhancement packet and packing the enhancement layers of the frames corresponding to the at least a first enhancement packet to form at least a third enhancement packet according to the features of the second bitstream parameter.

5. The method for packing the bitstream of SVC as claimed in claim 4, wherein the second bitstream parameter is one of quantization parameter and block size.

6. The method for packing the bitstream of SVC as claimed in claim 4, wherein the SVC bitstream further comprises a third bitstream parameter, and after the step of packing the enhancement layers of the frames corresponding to the base layer packet to form the at least a second enhancement packet and packing the enhancement layers of the frames corresponding to the at least a first enhancement packet to form the at least a third enhancement packet according to the features of the second bitstream parameter, the method further comprises:
packing the enhancement layers of the frames corresponding to the base layer packet to form at least a fourth enhancement packet and packing the enhancement layers of the frames corresponding to the at least a first enhancement packet to form at least a fifth enhancement packet according to the features of the third bitstream parameter; and
packing the enhancement layers of the frames corresponding to the base layer packet to form at least a sixth enhancement packet and packing the enhancement layers of the frames corresponding to the at least a first enhancement packet to form at least a seventh enhancement packet according to the features of the second bitstream parameter.

7. The method for packing the bitstream of SVC as claimed in claim 6, wherein the second bitstream parameter and the third bitstream parameter are block size or quantization parameter respectively, and the second bitstream parameter and the third bitstream parameter are different.

8. The method for packing the bitstream of SVC as claimed in claim 3, wherein the SVC bitstream further comprises a second bitstream parameter, and after the step of packing the base layers of all of the frames to form the base layer packet, the method further comprises:
packing the enhancement layers of the frames corresponding to the base layer packet to form at least a second enhancement packet according to the features of the second bitstream parameter.

9. The method for packing the bitstream of SVC as claimed in claim 8, wherein the second bitstream parameter is one of quantization parameter and block size.

10. The method for packing the bitstream of SVC as claimed in claim 8, wherein the SVC bitstream further comprises a third bitstream parameter, and after the step of packing the enhancement layers of the frames corresponding to the base layer packet to form the at least a second enhancement packet according to the features of the second bitstream parameter, the method further comprises:
packing the enhancement layers of the frames corresponding to the base layer packet to form at least a third enhancement packet according to the features of the third bitstream parameter; and
packing the enhancement layers of the frames corresponding to the base layer packet to form at least a fourth enhancement packet according to the features of the second bitstream parameter.

11. The method for packing the bitstream of SVC as claimed in claim 10, wherein the second bitstream parameter and the third bitstream parameter are block size or quantization parameter respectively, and the second bitstream parameter and the third bitstream parameter are different.

12. A method for packing a bitstream of scalable video coding (SVC), the method comprising:
obtaining a SVC bitstream, wherein the SVC bitstream comprises a plurality of frames, and each of the frames comprises a base layer and a plurality of enhancement layers;
analyzing complexity of the frames according to the features of a first bitstream parameter of the SVC bitstream; and
selectively packing the base layers of the frames to form a base layer packet according to the complexity of the frames; and
packing the enhancement layers of the frames corresponding to the base layer packet to form at least a first enhancement packet and at least a second enhancement packet according to a packing mechanism of the base layer packet and the features of a second bitstream parameter and a third bitstream parameter of the SVC bitstream.

13. The method for packing the bitstream of SVC as claimed in claim 12, further comprising:
packing the base layers of a portion of the frames to form a second base layer packet according to the complexity of the frames, and packing the base layers of the remainder of the frames to form at least a third enhancement packet, wherein the at least a third enhancement packet at least comprises a frame data estimated from a key picture; and
packing the enhancement layers of the frames corresponding to the base layer packet to form at least a fourth enhancement packet and a fifth enhancement packet, and packing the enhancement layers of the frames corresponding to the at least a third enhancement packet to form at least a sixth enhancement packet and a seventh enhancement packet according to the features of the second bitstream parameter and the third bitstream parameter of the SVC bitstream.

14. The method for packing the bitstream of SVC as claimed in claim 13, wherein the first bitstream parameter is motion vector, the second bitstream parameter and the third bitstream parameter are one of quantization parameter and block size respectively, and the second bitstream parameter and the third bitstream parameter are different.
